(19) United States
(12) Patent Application Publication
(10) Pub. No.: US 2024/0267228 A1
(43) Pub. Date: Aug. 8, 2024

(54) SYSTEM AND GATEWAY FOR ATTESTING A DATA RECORD

(71) Applicant: Riddle & Code GmbH, Wien (AT)

(72) Inventor: Thomas FÜRSTNER, Malta (MT)

(21) Appl. No.: 18/565,019

(22) PCT Filed: May 30, 2022
(86) PCT No.: PCT/EP2022/064619

§ 371 Date: Nov. 28, 2023

(30) Foreign Application Priority Data
May 28, 2021 (WO) PCT/EP2021/064410

(51) Int. Cl. H04L 9/32; H04L 9/00; H04L 9/08

(52) U.S. Cl. CPC H04L 9/3247; H04L 9/0897; H04L 9/3268; H04L 9/50

(57) ABSTRACT

A system for locally attesting a data record at a data source, the system including:
a trusted gateway locally connected to the data source and configured for receiving at least one data point from the data source;
at least one blockchain database configured for receiving and storing data records digitally signed with a cryptographic key; and
a certificate store,
wherein the trusted gateway comprises a secure element storing at least one private cryptographic key,
wherein the certificate store contains a digital certificate comprising a public cryptographic key corresponding to the at least one private cryptographic key digitally signed by a trusted certificate authority,
wherein the trusted gateway is configured to create a data record containing at least one data point and to transmit the created data record to the at least one blockchain database.

### TECHNICAL FIELD

The present invention concerns a system and method for locally attesting a data record at a data source. The system, which can be a distributed system, comprises: a trusted gateway (or trusted gateway device) locally connected to the data source and configured for receiving at least one data point from the data source, and at least one blockchain database configured for receiving and storing data records digitally signed with a cryptographic key, wherein the trusted gateway comprises a secure element storing at least one private cryptographic key, wherein the trusted gateway is configured to create a data record containing at least one data point received from the data source, a timestamp, an identity associated with the at least one private cryptographic key and at least one digital signature generated by the secure element with the at least one private cryptographic key, and to transmit the created data record to the at least one blockchain database. Moreover, the present invention also concerns a trusted gateway suitable for use in such a system and a method for initializing such a trusted gateway.

### BACKGROUND OF THE INVENTION

The purpose of such systems is to attest authenticity and origin of data from one particular data source to third parties. The attestation is performed by cryptography, more particularly by providing a digital signature of the data concerned, which digital signature can be verified by an interested third party.

US 2021/083883 A1 discloses a method for digitally signing sensor readings with a private key of a public/private key pair and related to a digital certificate from a certified authority. The signed sensor readings alongside with a related digital certificate can be submitted to a backend system implemented as a block chain system.

WO 2020/225488 A1 also concerns the certification of a measurement value by signing a measurement result with a secret key stored in a key storage of a data security module. The public key corresponding to the secret key is associated with a digital calibration certificate. The digital calibration certificate is defined for the device during or after manufacture.

One application that benefits particularly from the above type of system is the attestation of energy produced by participants of a distributed power system. In one specific embodiment, the present invention concerns the use of a system of the type defined above in a distributed power system, for example comprising solar power systems by multiple distributed participants.

KR 10-2163559 B1 discloses a power transaction system supporting transactions from distributed power sources by using electronic signatures and blockchain technology. The participants of the system use a so-called Energy Blockchain Hardware Wallet to attest power transaction information with a private key and transmit it to a blockchain network.

While the known system naturally enables legitimate power producers to prove, how much power they have been providing, is difficult for third parties to discern, which power producers are actually legitimate. It is in principle possible to generate a valid key pair outside the Energy Blockchain Hardware Wallet and generate transactions without actually producing any power.

### SUMMARY OF THE INVENTION

It is an object of the present invention to overcome or at least alleviate the disadvantages of the prior art.

The system according to the present invention further comprises a certificate store, wherein the certificate store contains a digital certificate comprising a public cryptographic key corresponding to the at least one private cryptographic digitally signed by a trusted certificate authority. The trusted certificate authority can be the producer of the trusted gateway or it can be a party trusted due to official standing or due to long-term contractual relationships, such as a local energy provider, for example. The certificate store can typically be a publicly accessible online repository for fetching existing certificates based on a valid identity of the participant (i.e., a trusted gateway). Alternatively, the certificate store may be a complete collection of certificates distributed to participants of the system. For example, a local energy provider can publish a downloadable certificate store, which can be downloaded by power consumers interested in verifying the origin of their consumed power. This may be particularly useful to transparently prove the amount of renewable energy provided from distributed sources.

The timestamp is optionally a current timestamp obtained from an integrated clock of the trusted gateway. The integrated clock can optionally by synchronized via a computer network, in particular via the Internet, for example using the Network Time Protocol (NTP) and trusted time servers according to a pre-defined list of time servers.

The at least one blockchain database (or at least one of two or more blockchain databases) can optionally be a permissioned blockchain database configured for receiving and storing data records digitally signed with a cryptographic key registered in a permission whitelist, wherein a public cryptographic key corresponding to the at least one private cryptographic key is registered in the permission whitelist. In this case, the presence of a transaction on the blockchain provides a first level of proof that the transaction has been created by a legitimate source. However, secure and complete verification would require to at least partially verify the blockchain itself. Even then, one would need to trust the security of the permission whitelist. Therefore, even in this scenario, a higher level of security can be achieved by obtaining the certificate corresponding to the transaction source and verifying the signature with the obtain certificate. This verification path also likely requires less computational and network resources and is therefore faster and generally more reliable.

According to an optional embodiment, the secure element may store at least two different private cryptographic keys, wherein the public cryptographic key digitally signed by the trusted certificate authority and the cryptographic key registered in the permission whitelist correspond to different private cryptographic keys. Both private cryptographic keys should be generated and securely stored within the secure element itself similar to a single private cryptographic key. Moreover, it is also the secure element, that computes and provides the corresponding public cryptographic keys to the trusted gateway and that generates and provides digital signatures using any of the private cryptographic keys. Consequently, the trusted gateway will specify, which key pair (or identity) shall be applied when requesting a signature from the secure element.

In this context, the trusted gateway may optionally be configured to include two digital signatures generated by the secure element in the data record, wherein each digital signature may be generated with a different private cryptographic key. This allows for the two signing functions, that is, the attestation of permission to the blockchain on the one hand and the attestation of a certified source on the other hand, to be attached to different key pairs. Such a separation of concerns generally reduces the impact of a weakness of any of the two key pairs. It also allows for a more fine-grained control over the publicity of the association of cryptographic identities with hardware devices and especially their owners.

One purpose of the (at least) two digital signatures is to fulfil different functions. The first signature, by a first identity (equivalent to a signing private key), may have the function of attesting the identity of the trusted gateway and with it the identity of the device behind the trusted gateway, i.e., the data source. The public cryptographic key corresponding to the first identity may be digitally signed by a trusted certificate authority, which may be the producer or vendor of the trusted gateway or of the data source. The purpose of this attestation is to secure the provenance of the data record and optionally any connected quality guarantees made by the certificate authority, e.g., regarding the quality control or security of the data source. The first identity may be a non-removable identity of the trusted gateway and—when the trusted gateway is physically non-removable attached to the data source—of the data source. The concept established by and connected to the first identity is that of a digital twin of the physical device. There is a one-to-one relationship between the first identity (which is digital) and the trusted gateway (which is physical) and optionally any securely physically attached data source. The second signature, by a second identity (equivalent to a different signing private key), may have the function of attesting a secure relationship with a single related entity, e.g., a beneficiary or shareholder of the trusted gateway. The second signature guarantees a unique relationship between the content of the data record and exactly one related entity. The second identity may be a removable identity. That means, the trusted gateway may accept or generate itself a new second identity, replacing the previous second identity. This allows, e.g., for flexible beneficiaries, while ensuring that there is always exactly one and only one beneficiary of a particular data record. It avoids the need of a complicated certification scheme as the first, and certified, identity remains unaffected while the second identity can be replaced without compromising the function achieved by the first identity.

In an alternative optional embodiment, the trusted gateway may be configured to include two digital signatures generated by the secure element in the data record, wherein each digital signature is generated using a different public key algorithm from the same private cryptographic key or from different private cryptographic keys. This approach allows for broader support and compatibility with different cryptographic schemes.

The at least one digital signature may for example use a signing algorithm based on public-key cryptography, in particular on elliptic-curve cryptography. Specifically, the signing may be based on the Elliptic Curve Digital Signature Algorithm (ECDSA), e.g., using the secp256k1-curve, or on the Edwards-curve Digital Signature Algorithm (EdDSA), e.g., using the twisted Montgomery curve (Ed25519).

Optionally, the trusted gateway may be configured to include the digital certificate in the data record. For example, the digital certificate may be included upon creation of the data record in form and integral part of the transaction distributed on the blockchain. This facilitates verification of the signature based on the transaction data alone. The verifying third-party needs only access to the root certificate of the certificate authority to verify first the source certificate based on the signature by the certificate authority and second the transaction based on the signature by the source identity.

As pointed out in the introduction, in one exemplary application, the data source may be a power meter, in particular a solar power meter, or an electricity meter, wherein the data point is a power reading (for example a measured power value) or an energy reading (for example the energy flow of the last hour, or hourly energy change).

In another exemplary application, the data source may be a car, in particular a CAN bus of a car, wherein the data point is a status reading received via the CAN bus (for example a tyre pressure or engine temperature or other measurements or status information related to the internal systems of the car). In this case, the trusted provider of the trusted gateway can attest to the origin and optionally type of the car and thus allows cryptographic verification of the genuineness of the provided data points.

The trusted gateway may be connected to the data source via a direct, preferably wired, connection. For example, this connection may be established in a secured environment, under the control and supervision of the trusted provider. In addition, hardware means may be foreseen in the trusted gateway to ensure detection of tampering with the connection to the data source to avoid replacement of and forgery in the data source.

The trusted gateway may further be configured to receive data points from the data source in digitally signed and/or encrypted form and to verify the signature and/or decrypt the data point before creating a data record. The cryptographic key used by the data source does not have to be unique in order to protect against fraudulent replacement of the genuine data source with a forged data source.

The method for locally attesting a data record at a data source proposed by the present disclosure comprises:
receiving at least one a data point from the data source with a trusted gateway device connected to the data source;
creating by the trusted gateway a data record containing the data point received from the data source, a timestamp, an identity associated with the at least one private cryptographic key and at least one digital signature generated by a secure element of the trusted gateway with the at least one private cryptographic key stored by the secure element;
transmitting the created data record to at least one blockchain database.

As discussed above for the system, the at least one blockchain database may optionally be a permissioned blockchain database, in which case the method further comprises:
receiving by the permissioned blockchain database the data record;
checking that the identity is associated with the at least one signature of the data record is registered in a permission whitelist of the permissioned blockchain database.

Alternatively (or additionally in case of two or more blockchains), the at least one blockchain database (or one of the multiple blockchain databases) may be a public (optionally permissionless) blockchain database, the method further comprising:
fetching the data record from the public blockchain database;
fetching a digital certificate comprising a public cryptographic key corresponding to the at least one private cryptographic digitally signed by a trusted certificate authority from a certificate store;
authenticating the data record using the at least one digital signature and the certificate.

The present disclosure also proposes a method for initializing a trusted gateway (in a secure environment) for use in the system according to one of the embodiments discussed above, the method comprising:
triggering the generation of at least one new key pair within the secure element;
obtaining the public key of the at least one new key pair from the secure element;
signing the obtained public key with a private key of the certificate authority to obtain a new digital certificate; and
registering the new digital certificate in the certificate store.

The present disclosure proposes a similar method, which may be performed alternatively or additionally to the above initialisation, if the trusted gateway shall be used together with a permissioned blockchain, wherein the method comprises:
triggering the generation of at least one new key pair within the secure element;
obtaining the public key of the at least one new key pair from the secure element;
adding the obtained public key to the permission whitelist.

The public key added to the permission of at least a be the same or a different public key as that used for creating the new digital certificate, is both methods for initialisation are combined.

Finally, the present disclosure also relates to a trusted gateway comprising:
a first data connection interface for connecting to a data source;
a second data connection interface connected to a wireless broadband communication uplink device, in particular a cellular network modem;
a secure element storing at least one private cryptographic key;
wherein the trusted gateway is configured to receive at least one data point from a data source via the first data connection interface, to create a data record containing the at least one data point received from the data source, a timestamp, an identity associated with the at least one private cryptographic key and at least one digital signature generated by the secure element with the at least one private cryptographic key, and to transmit the created data record via the second data connection interface.

The embodiments described above in relation to the system also applied to the trusted gateway, which may be configured to work in any of the variations of the system. Additionally, the trusted gateway may be initialised according to one or more of the methods for initialisation disclosed above.

### BRIEF DESCRIPTION OF THE DRAWING

Referring now to the drawings, wherein the FIGURE is for purposes of illustrating the present invention and not for purposes of limiting the same:

FIG. 1 shows a schematic overview over a system according to an exemplary embodiment of the present disclosure.

### DETAILED DESCRIPTION OF THE DRAWING

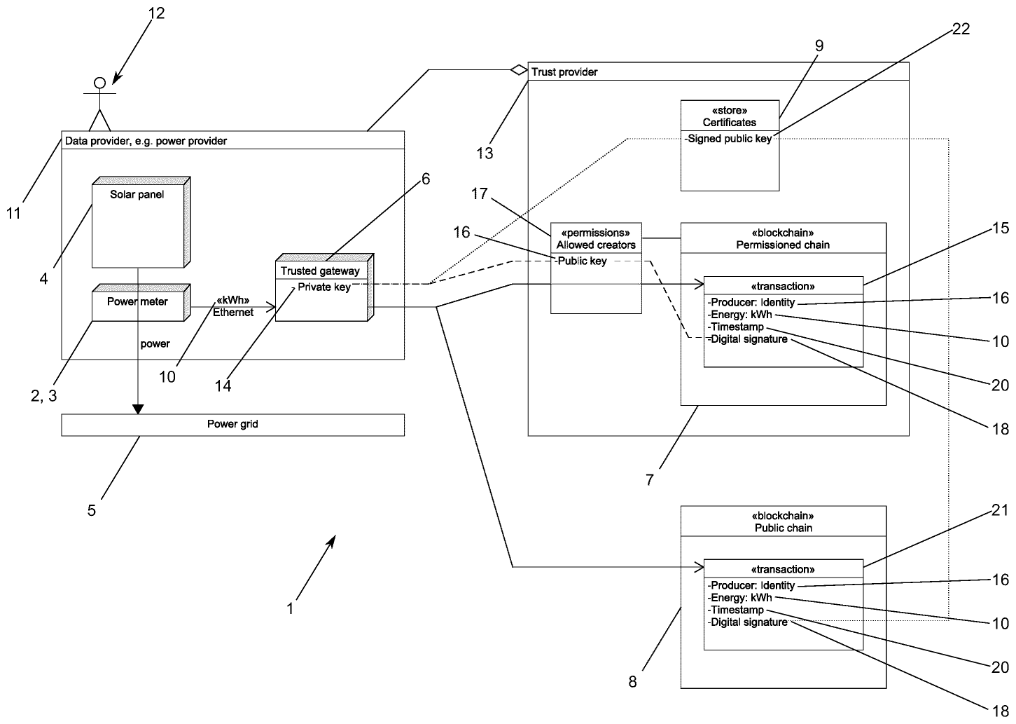

FIG. 1 shows a system 1 for locally attesting a data record at a data source 2. In this example, the data source 2 is a power metre 3 measuring the energy produced by a solar panel 4 (or generally solar power system) and provided to a power grid 5. The system 1 comprises a trusted gateway 6, two blockchain databases 7, 8 and a certificate store 9. The trusted gateway 6 is locally connected to the data source 2. It is configured for receiving at least one data point 10 from the power metre 3. In this example, the trusted gateway 6 is connected to the power metre 3 via Ethernet. It receives measurement values in units of kWh as data points 10 on a regular basis, for example hourly or daily. As indicated by an enclosing box 11, the trusted gateway 6, the power metre 3 and the solar panel 4 are under the control and ownership of the individual power provider 12, acting as data provider in this example.

The data/power provider 12 in this distributed system is one of several data/power providers served by the trust provider 13. The trust provider 13 hosts a first blockchain database 7. The first blockchain database 7 is configured for receiving and storing data records digitally signed with a cryptographic private key 14. The first blockchain database 7 is a permissioned blockchain database. For a transaction 15 to be allowed into (and stored in) the first blockchain database 7, they must be signed by an identity 16 registered on the permission whitelist 17. That means, the transaction 15 must contain a digital signature 18 from one of those identities.

The trusted gateway 6 may be formed by a combination of an embedded computer with a secure element. The embedded computer (e.g., a Raspberry Pi) acts as a host device and performs all necessary computations. The secure element is responsible for cryptographic operations and for providing a secure storage. The secure element stores the private cryptographic key 14. The secure element may for example be an SEO50C by NXP Semiconductors. The trusted gateway 6 is configured to create a data record. That data record serves as a basis for creating transaction 15 on any of the two blockchains 7, 8. The term “data record” is used as a more general term to indicate that what makes the data record a transaction is the fact, that it is included in any of the blockchains 7, 8. Another—less precise—term for the data record would be “pending transaction” or “preliminary transaction”.

The data record created by the trusted gateway 6 in preparation of a transaction 15 contains at least one data point 10 received from the data source 2 and a current timestamp 20 obtained from an integrated clock of the trusted gateway 6. These two parts are then digitally signed using the secure element. In detail, a digital signature 18 is generated by the secure element with the private cryptographic key 14 stored thereon. The digital signature uses the Edwards-curve Digital Signature Algorithm (EdDSA) with the twisted Montgomery curve (Ed25519). The resulting digital signature itself as well as the EdDSA public key 16 (or a derived identity, e.g., an “address”) cryptographically associated with the private cryptographic key 14 are included in the data record by the trusted gateway 6.

The trusted gateway 6 is further configured to transmit the created data record obtained as described above to the first blockchain database 7. The first blockchain database 7 is a permissioned blockchain database. It is configured for receiving and storing only those data records, which are digitally signed with a cryptographic key registered in its associated permission whitelist 17, that is, according to its blockchain network configuration. The public cryptographic key 16 corresponding to the private cryptographic key 14 of the trusted gateway 6 is registered in the permission whitelist 17. Therefore, the data record is accepted and included as transaction 15 in the first blockchain database 7.

The trusted gateway 6 is further configured to transmit the created data record obtained as described above to a second blockchain database 8. The second blockchain database 8 is a public (generally permissionless) blockchain database. It is configured for receiving and storing any valid (that is, complete and error-free) data records. Third parties accessing transactions in the second blockchain database 8 can still verify the origin and authenticity of the reported transactions 21 by requesting from the certificate store 9 a digital certificate 22 corresponding to the identity of the alleged producer of the transaction 21. The certificate store 9 contains a digital certificate 22 comprising a public cryptographic key 16 corresponding to the private cryptographic key 14 digitally signed by the trust provider 13 acting as trusted certificate authority. The third party can therefore verify the authenticity of the data provider certificate 22 with a trust provider root certificate and then verify the authenticity of the digital signature 18 of the transaction 21 with the data provider certificate 22. This allows the individual data provider 12 to participate in public blockchain networks of their choice, effectively without compromising on the verifiability of their transactions by third parties.

In one particular exemplary embodiment of the present system applied to distributed solar power production, an independent producer owns a solar power system. This may be a private home owner having a photovoltaic system installed on the roof of their home or otherwise integrated in the building. The solar power system generates energy in the form of electricity. The generated energy is measured by the local energy provider and the measurement data is collected, e.g., by a closed and sealed electricity metre installed by the local energy provider between the solar power system and the power grid. The collected measurement data is transmitted to the adjusted gateway via a direct network connection (e.g., TCP/IP via Ethernet). The trusted Gateway can be integrated directly in the solar power system or in the electricity metre. The trusted gateway essentially signs the received measurement data (that is, the amount of energy measured, e.g., in kWh units) with a private key stored in the secure element. It then transmits the signed measurement data via an Internet connection to a blockchain database instance operated by a trusted party. The Internet connection may be provided by an LTE or 4G modem integrated into the trusted gateway and including an antenna and Sim card for an Internet uplink via a mobile broadband network. The blockchain database instance may be running the BigchainDB software system (see https://github.com/bigchaindb/bigchaindb).

In addition, the trusted Gateway also creates a transaction containing the measurement data and a digital signature for a second blockchain database and publishes generated transaction to the second blockchain database. Said second blockchain database may be the public Interplanetary Database (IPDB) network.

The transaction comprises at least four pieces of information: a timestamp indicating the absolute time at which an amount of energy has been produced; the amount of actual produced energy in units of kWh; a digital signature of the timestamp and amount; and a public key corresponding to a device identifier of the trusted Gateway, which can be used for authenticating the digital signature.

The trusted gateway is protected against tampering by accepting only cryptographically signed software updates digitally signed by the producer of the trusted Gateway. In addition, the secure element protects the at least one private key stored thereon and allows for unique and secure identification of the trusted gateway.

The present example, the secure element generates two pairs of cryptographic keys and store stone securely. One of the two key pairs represents the unique device identifier. The other key pair represents a unique identity and address on the second blockchain database (the IPDB). It is impossible to extract the private keys from the secure element or otherwise gain knowledge thereof, due to hardware tamper protection measures of the secure element. That means, that the owner of the trusted Gateway does not know the private keys, but can only use them by means of the trusted gateway. The private keys stored encrypted within the secure element and never leave the secure element. They form part of the digital, cryptographic identity of the respective device. There used for generating digital signatures, which digital signatures are therefore unambiguously associated with the respective trusted Gateway.

Consequently, when a data record is signed by the secure element, that means, that exactly this data is probably generated by the respective device. For this example, the particular amount of energy indicated in the transaction is provably produced by the solar power system connected to the particular trusted gateway (proof of origin) and information of the produced amount of energy as well as the particular time of production can be verified (proof of integrity and authenticity). The verification can be performed with the public key, which is the corresponding public part of the key pair, to which the signing private key belongs. This public key can be publicly accessible and is also part of the transaction.

Of the two key pairs mentioned above, first key pair used for signing the data uses the Elliptic Curve Digital Signature Algorithm (ECDSA) with the secp256k1-curve. This key pair forms the device identity. The other key pair uses the Edwards-curve Digital Signature Algorithm (EdDSA) with the twisted Montgomery curve (Ed25519). The IPDB transaction comprises the complete data record as described above, including the signature and public key of the first key pair, and is further signed with the private key of the second key pair.

1. A system for locally attesting a data record at a data source, the system comprising:
a trusted gateway locally connected to the data source and configured for receiving at least one data point from the data source;
at least one blockchain database configured for receiving and storing data records digitally signed with a cryptographic key;
wherein the trusted gateway comprises a secure element storing at least one private cryptographic key,
wherein the trusted gateway is configured to create a data record containing at least one data point received from the data source, a timestamp, an identity associated with the at least one private cryptographic key and at least one digital signature generated by the secure element with the at least one private cryptographic key, and to transmit the created data record to the at least one blockchain database (7, 8),
wherein the system further comprises a certificate store,
wherein the certificate store contains a digital certificate comprising a public cryptographic key corresponding to the at least one private cryptographic key digitally signed by a trusted certificate authority.

2. The system according to claim 1, wherein the at least one blockchain database is a permissioned blockchain database configured for receiving and storing data records digitally signed with a cryptographic key registered in a permission whitelist, wherein a public cryptographic key corresponding to the at least one private cryptographic key is registered in the permission whitelist.

3. The system according to claim 2, wherein the secure element stores at least two different private cryptographic keys, wherein the public cryptographic key digitally signed by the trusted certificate authority and the cryptographic key registered in the permission whitelist correspond to different private cryptographic keys.

4. The system according to claim 3, wherein the trusted gateway is configured to include two digital signatures generated by the secure element in the data record, wherein each digital signature is generated with a different private cryptographic key.

5. The system according to claim 2, wherein the trusted gateway is configured to include two digital signatures generated by the secure element in the data record, wherein each digital signature is generated using a different public key algorithm from the same private cryptographic key or from different private cryptographic keys.

6. The system according to claim 1, wherein the at least one digital signature uses a signing algorithm based on public-key cryptography.

7. The system according to claim 1, wherein the trusted gateway is configured to include the digital certificate in the data record.

8. The system according to claim 1, wherein the data source is a power meter, wherein the data point is a power reading or an energy reading.

9. The system according to claim 1 to 7, wherein the data source is a car, including a CAN bus of a car, wherein the data point is a status reading received via the CAN bus.

10. The system according to claim 1, wherein the trusted gateway is connected to the data source via a direct, preferably wired, connection.

11. The system according to claim 1, wherein the trusted gateway is configured to receive data points from the data source in digitally signed and/or encrypted form and to verify the signature and/or decrypt the data point before creating a data record.

12. A method for locally attesting a data record at a data source, the method comprising:
receiving at least one a data point from the data source with a trusted gateway connected to the data source;
creating by the trusted gateway a data record containing the data point received from the data source, a timestamp, an identity associated with the at least one private cryptographic key and at least one digital signature generated by a secure element of the trusted gateway with the at least one private cryptographic key stored by the secure element;
transmitting the created data record to at least one blockchain database.

13. The method according to claim 12, wherein the at least one blockchain database is a permissioned blockchain database, the method further comprising:
receiving by the permissioned blockchain database the data record;
checking that the identity is associated with the at least one signature of the data record and is registered in a permission whitelist of the permissioned blockchain database.

14. The method according to claim 12, wherein the at least one blockchain database is a public blockchain database, the method further comprising:
fetching the data record from the public blockchain database;
fetching a digital certificate comprising a public cryptographic key corresponding to the at least one private cryptographic key digitally signed by a trusted certificate authority from a certificate store;
authenticating the data record using the at least one digital signature and the certificate.

15. A trusted gateway for attesting a data record comprising:
a first data connection interface for connecting to a data source;
a second data connection interface connected to a wireless broadband communication uplink device;
a secure element storing at least one private cryptographic key;
wherein the trusted gateway is configured to receive at least one data point from a data source via the first data connection interface, to create a data record containing the at least one data point received from the data source, a timestamp, an identity associated with the at least one private cryptographic key and at least one digital signature generated by the secure element with the at least one private cryptographic key, and to transmit the created data record via the second data connection interface.
